(19) United States
(12) Patent Application Publication
(10) Pub. No.: US 2024/0256359 A1
(43) Pub. Date: Aug. 1, 2024

(54) SYSTEMS AND METHODS FOR IDENTIFYING AND UTILIZING STRANDED COMPUTING RESOURCES

(71) Applicant: Dell Products L.P., Round Rock, TX (US)

(72) Inventors: John Thomas Cardente, Milford, MA (US); Gaurav Chawla, Austin, TX (US); Douglas Lang Farley, Round Rock, TX (US); Kirk A. Frey, Flemington, NJ (US); Anna Groves, Austin, TX (US); Robert Anthony Lincourt, JR., Franklin, MA (US); Tommi Salli, Austin, TX (US); John S. Harwood, Boston, MA (US)

(21) Appl. No.: 18/160,150

(22) Filed: Jan. 26, 2023

(51) Int. Cl. G06F 9/50; G06F 9/455

(52) U.S. Cl. CPC G06F 9/5077; G06F 9/45558; G06F 2009/45562; G06F 2009/45583; G06F 2209/503

(57) ABSTRACT

A method for allocating stranded computing resources, the method that includes obtaining, by a virtual machine manager, virtual machine parameters for a virtual machine, identifying, in a computing resource database, a stranded computing resource satisfying the virtual machine parameters, allocating, to the virtual machine, the stranded computing resource, and initiating the virtual machine using the stranded computing resource.

### BACKGROUND

Devices are often capable of performing certain functionalities that other devices are not configured to perform, or are not capable of performing. In such scenarios, it may be desirable to adapt one or more systems to enhance the functionalities of devices that cannot perform those functionalities.

### BRIEF DESCRIPTION OF DRAWINGS

FIG. 1A shows a diagram of a system, in accordance with one or more embodiments.

FIG. 1B shows a diagram of a domain, in accordance with one or more embodiments.

FIG. 1C shows a diagram of a creation request, in accordance with one or more embodiments.

FIG. 1D shows a diagram of a computing resource database, in accordance with one or more embodiments.

FIG. 1E shows a diagram of an allocation database, in accordance with one or more embodiments.

FIG. 2A shows a flowchart of a method for creating a virtual machine, in accordance with one or more embodiments.

FIG. 2B shows a flowchart of a method for monitoring computing resources and enforcing virtual machine parameters, in accordance with one or more embodiments.

FIG. 2C shows a flowchart of a method for scaling virtual machines based on computing resource utilization, in accordance with one or more embodiments.

FIG. 3A shows an example of computing resources allocated to multiple virtual machines, in accordance with one or more embodiments.

FIG. 3B shows an example of computing resources allocated to multiple virtual machines, in accordance with one or more embodiments.

FIG. 3C shows an example of computing resources allocated to multiple virtual machines, in accordance with one or more embodiments.

FIG. 3D shows an example of computing resources allocated to a virtual machine, in accordance with one or more embodiments.

### DETAILED DESCRIPTION

### General Notes

As it is impracticable to disclose every conceivable embodiment of the described technology, the figures, examples, and description provided herein disclose only a limited number of potential embodiments. One of ordinary skill in the art would appreciate that any number of potential variations or modifications may be made to the explicitly disclosed embodiments, and that such alternative embodiments remain within the scope of the broader technology. Accordingly, the scope should be limited only by the attached claims. Further, certain technical details, known to those of ordinary skill in the art, may be omitted for brevity and to avoid cluttering the description of the novel aspects.

For further brevity, descriptions of similarly-named components may be omitted if a description of that similarly-named component exists elsewhere in the application. Accordingly, any component described with regard to a specific figure may be equivalent to one or more similarly-named components shown or described in any other figure, and each component incorporates the description of every similarly-named component provided in the application (unless explicitly noted otherwise). A description of any component is to be interpreted as an optional embodiment-which may be implemented in addition to, in conjunction with, or in place of an embodiment of a similarly-named component described for any other figure.

### Lexicographical Notes

As used herein, adjective ordinal numbers (e.g., first, second, third, etc.) are used to distinguish between elements and do not create any particular ordering of the elements. As an example, a “first element” is distinct from a “second element”, but the “first element” may come after (or before) the “second element” in an ordering of elements. Accordingly, an order of elements exists only if ordered terminology is expressly provided (e.g., “before”, “between”, “after”, etc.) or a type of “order” is expressly provided (e.g., “chronological”, “alphabetical”, “by size”, etc.). Further, use of ordinal numbers does not preclude the existence of other elements. As an example, a “table with a first leg and a second leg” is any table with two or more legs (e.g., two legs, five legs, thirteen legs, etc.). A maximum quantity of elements exists only if express language is used to limit the upper bound (e.g., “two or fewer”, “exactly five”, “nine to twenty”, etc.). Similarly, singular use of an ordinal number does not imply the existence of another element. As an example, a “first threshold” may be the only threshold and therefore does not necessitate the existence of a “second threshold”.

As used herein, the word “data” is used as an “uncountable” singular noun—not as the plural form of the singular noun “datum”. Accordingly, throughout the application, “data” is generally paired with a singular verb (e.g., “the data is modified”). However, “data” is not redefined to mean a single bit of digital information. Rather, as used herein, “data” means any one or more bit(s) of digital information that are grouped together (physically or logically). Further, “data” may be used as a plural noun if context provides the existence of multiple “data” (e.g., “the two data are combined”).

As used herein, the term “operative connection” (or “operatively connected”) means the direct or indirect connection between devices that allows for interaction in some way (e.g., via the exchange of information). For example, the phrase ‘operatively connected’ may refer to a direct connection (e.g., a direct wired or wireless connection between devices) or an indirect connection (e.g., multiple wired and/or wireless connections between any number of other devices connecting the operatively connected devices).

### Overview and Advantages

In general, this application discloses one or more embodiments of systems and methods for identifying and utilizing stranded computing resources. In a system of many computing devices, computing resources may be allocated such that smaller portion of the resources remain unallocated and unutilized. Methods and systems are described herein that identify, allocate, and ensure the utilization of those otherwise underutilized and/or unallocated computing resources scattered throughout a domain of computing devices.

In conventional enterprise systems, the allocation of computing resources to two or more isolated software instances (e.g., virtual machines) may result in the inefficient distribution of those computing resources. As a non-limiting example, a virtual machine may request 7 GB of memory on a single device. Accordingly, the virtual machine is allocated 7 GB of memory from an 8 GB memory device. However, 1 GB of memory is left “stranded” (unallocated and unused) on that memory device. Then, a second virtual machine requests 10 GB of memory evenly split across two memory devices. Accordingly, 5 GB of a second 8 GB memory device is allocated, and 5 GB of a third 8 GB memory device are allocated. This further results in 3 GB of “stranded” memory on the second and third memory devices. In such an example, 7 GB (of the 24 GB memory) is unallocated and split into uneven sizes across three memory devices.

As disclosed in one or more embodiments herein, methods and systems are provided that allow for the identification and utilization of “stranded” computing resources. As discussed further below, virtual machines may be created using virtual machine parameters that allow (or disallow) for the utilization of “stranded” resources. Further, additional methods are provided for scaling-up existing virtual machines to use additional “slack” (unused and available computing resources). Accordingly, computing resources are allocated more efficiently, and virtual machines may be created with increased configurability to better suit the specific needs of the virtual machine.

The following sections describe figures which are directed to various non-limiting embodiments of the technology.

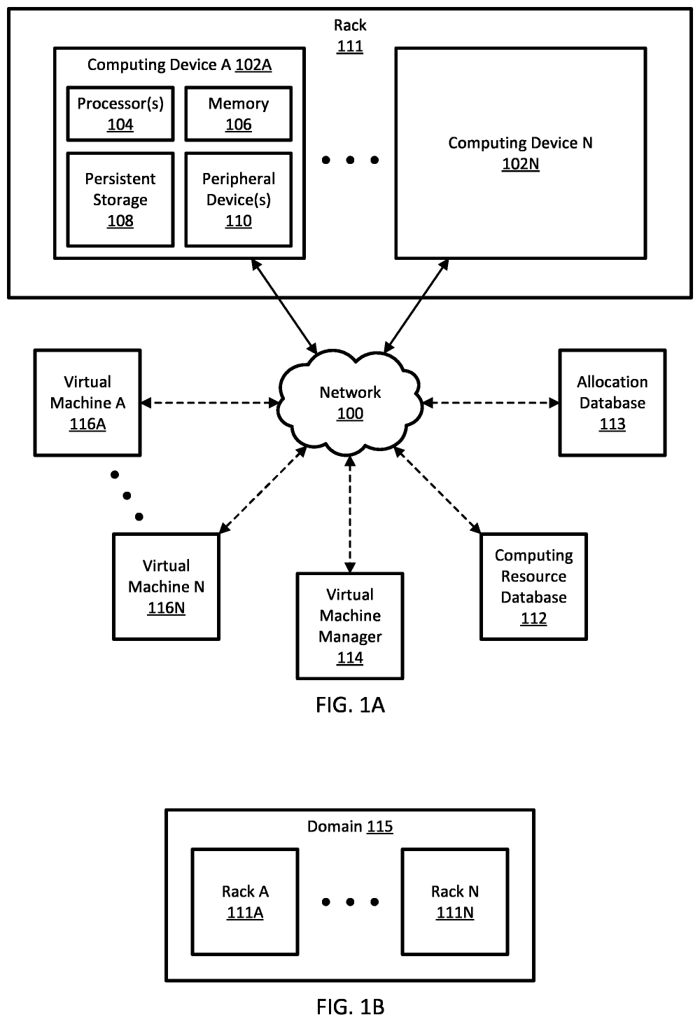

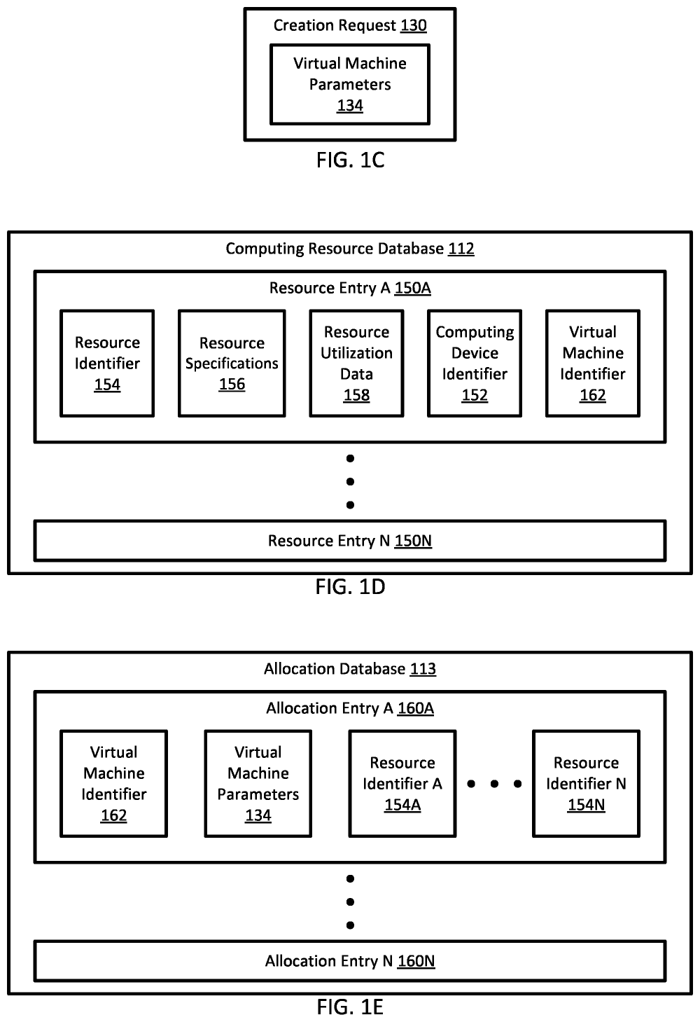

### FIG. 1A

FIG. 1A shows a diagram of a system, in accordance with one or more embodiments. While a specific configuration of a system is shown, other configurations may be used without departing from the disclosed embodiment. Accordingly, embodiments disclosed herein should not be limited to the configuration of devices and/or components shown.

In one or more embodiments, a system may include one or more rack(s) (111), computing device(s) (102), a network (100), a computing resource database (112), an allocation database (113), a virtual machine manager (114), and one or more virtual machine(s) (116). Each of these components is described below.

In one or more embodiments, a network (e.g., network (100)) is a collection of connected network devices (not shown) that allow for the communication of data from one network device to other network devices, or the sharing of resources among network devices. Non-limiting examples of a network (e.g., network (100)) include a local area network (LAN), a wide area network (WAN) (e.g., the Internet), a mobile network, any combination thereof, or any other type of network that allows for the communication of data and sharing of resources among network devices and/or computing devices (102) operatively connected to the network (100). One of ordinary skill in the art, having the benefit of this detailed description, would appreciate that a network is a collection of operatively connected computing devices that enables communication between those computing devices.

In one or more embodiments, a computing device (e.g., computing device A (102A), computing device N (102N)) is hardware that includes any one, or combination, of the following components:
(i) processor(s) (104) (described below),
(ii) memory (106) (described below),
(iii) persistent storage (108) (described below),
(iv) communication interface(s) (e.g., network ports, small form-factor pluggable (SFP) ports, wireless network devices, etc.) (described below),
(v) internal physical interface(s) (e.g., serial advanced technology attachment (SATA) ports, peripheral component interconnect (PCI) ports, PCI express (PCIe) ports, next generation form factor (NGFF) ports, M.2 ports, etc.),
(vi) external physical interface(s) (e.g., universal serial bus (USB) ports, recommended standard (RS) serial ports, audio/visual ports, etc.),
(vii) input and output device(s) (e.g., mouse, keyboard, a visual display device (monitor), joystick, gamepad, other human interface devices, compact disc (CD) drive, other non-transitory computer readable medium (CRM) drives, etc.), and/or
(viii) peripheral device(s) (110) operatively connected to internal and/or external physical interface(s) (e.g., graphics processing unit (GPU), data processing unit (DPU), sound card, audio/video capture card, etc.).

Non-limiting examples of a computing device (102) include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of computing device (102) with the aforementioned capabilities. In one or more embodiments, a computing device (102) may be operatively connected to another computing device (102) via a network (100).

In one or more embodiments, a processor (104) is an integrated circuit for processing computer instructions. In one or more embodiments, persistent storage (108) (and/or memory (106)) may store software that is executed by the processor(s) (104). A processor (104) may be one or more processor cores or processor micro-cores.

In one or more embodiments, memory (106) is one or more hardware devices capable of storing digital information (e.g., data) in a non-transitory medium. In one or more embodiments, when accessing memory (106), software may be capable of reading and writing data at the smallest units of data normally accessible (e.g., “bytes”). Specifically, in one or more embodiments, memory (106) may include a unique physical address for each byte stored thereon, thereby enabling software to access and manipulate data stored in memory (106) by directing commands to a physical address of memory that is associated with a byte of data (e.g., via a virtual-to-physical address mapping). Non-limiting examples of memory (106) devices include flash memory, random access memory (RAM), dynamic RAM (DRAM), static RAM (SRAM), and resistive RAM (ReRAM). In one or more embodiments, memory (106) may be volatile or non-volatile.

In one or more embodiments, persistent storage (108) (i.e., “storage”) is one or more hardware devices capable of storing digital information (e.g., data) in a non-transitory medium. Non-limiting examples of persistent storage (108) include integrated circuit storage devices (e.g., solid-state drive (SSD), Non-Volatile Memory Express (NVMe), flash memory, etc.), magnetic storage (e.g., hard disk drive (HDD), floppy disk, tape, diskette, etc.), and optical media (e.g., compact disc (CD), digital versatile disc (DVD), etc.). In one or more embodiments, prior to reading and/or manipulating data located on persistent storage (108), data may first be required to be copied in “blocks” (instead of “bytes”) to other, intermediary storage mediums (e.g., memory) where the data can then be accessed in “bytes”.

In one or more embodiments, a communication interface is a hardware component that provides capabilities to interface a computing device (102) with one or more other computing device(s) (102) (e.g., through a network (100) to another computing device (102), another server, a network of devices, etc.) and allow for the transmission and receipt of data with those devices. A communication interface may communicate via any suitable form of wired interface (e.g., Ethernet, fiber optic, serial communication etc.) and/or wireless interface and utilize one or more protocols for the transmission and receipt of data (e.g., transmission control protocol (TCP)/internet protocol (IP), remote direct memory access (RDMA), Institute of Electrical and Electronics Engineers (IEEE) 801.11, etc.).

As used herein, “software” means any set of instructions, code, and/or algorithms that are used by a computing device (102) to perform one or more specific task(s), function(s), or process(es). A computing device (102) may execute software (e.g., via processor(s) (104) and memory (106)) which read and write data stored on one or more persistent storage device(s) (108) and/or memory device(s) (106). Software may utilize resources from one or more computing device(s) (102) simultaneously and may move between computing devices (102), as commanded (e.g., via network (100)). Additionally, multiple software instances may execute on a single computing device (102) simultaneously.

In one or more embodiments, a computing resource is any one of the components, or subcomponents, of a computing device (102). Computing resources may be allocated to software (e.g., virtual machines (116)) for use by that software. Non-limiting examples of a computing resource include a processor (104), a processor core, a processor thread, any range of memory (106), any block(s) on a persistent storage (108) device, and any peripheral device components or sub-components (e.g., a GPU, a portion of processing time on a GPU, etc.).

In one or more embodiments, a stranded computing resource (or stranded resource) is an unused and/or unallocated computing resource where most of the rest of the physical hardware components has been allocated. As a non-limiting example, if 30 GB of a 32 GB memory (106) device is allocated, the remaining unallocated 2 GB may be a “stranded resource”. As another non-limiting example, if seven cores of an eight-core processor (104) are allocated, the remaining, unallocated core would be a “stranded resource”.

In one or more embodiments, a computing resource database (112) is a data structure which includes information about computing resources. Additional details regarding the computing resource database (112) may be found in the description of FIG. 1D.

In one or more embodiments, an allocation database (113) is a data structure which includes information about the allocation of computing resources. Additional details regarding the allocation database (113) may be found in the description of FIG. 1E.

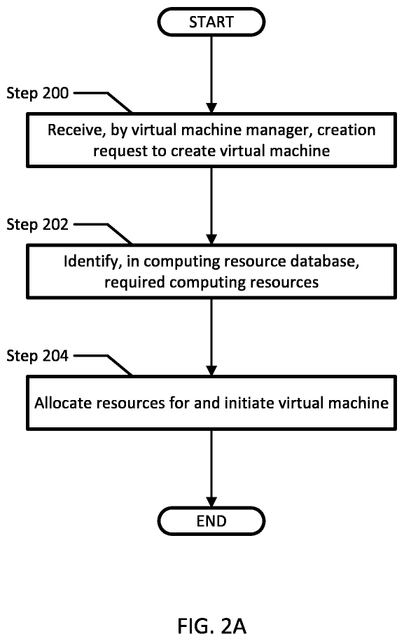

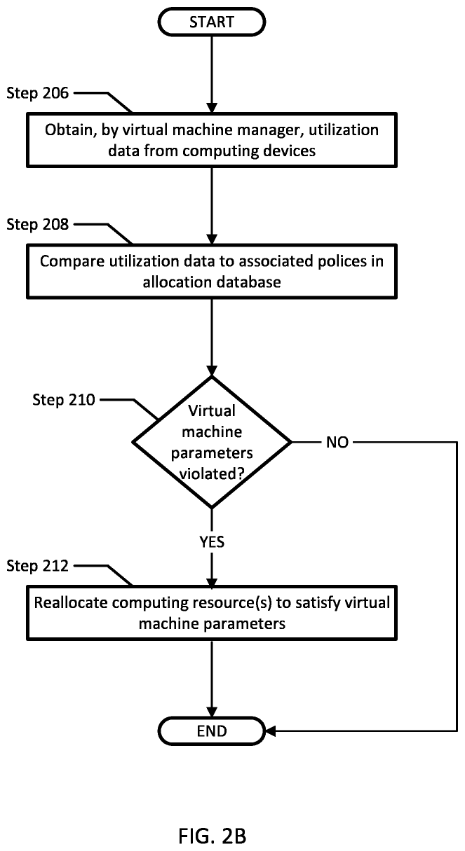

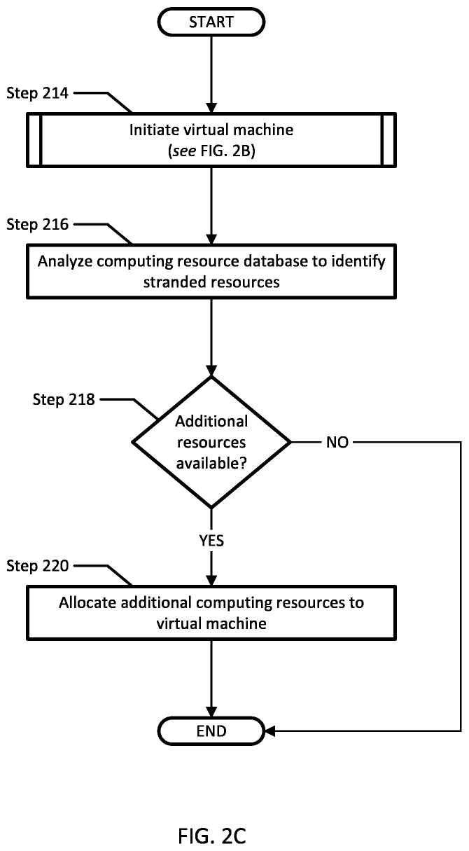

In one or more embodiments, a virtual machine manager (114) is software, executing on a computing device, which manages (e.g., creates, generates, initiates, scales, terminates, etc.) virtual machines (116). A virtual machine manager (114) may use the computing resource database (112) to identify, locate, and allocate computing resources of one or more computing device(s) (102) to virtual machines. Additional details regarding the functions of the virtual machine manager (114) may be found in the description of FIGS. 2A-C.

In one or more embodiments, a virtual machine (e.g., virtual machine A (116A), virtual machine (116N)) is software, executing on one or more computing device(s) (102), that provides a virtual environment in which other software (e.g., a program, a process) may execute. In one or more embodiments, a virtual machine (116) is created by a virtual machine manager (114) and is allocated computing resources (e.g., processor(s) (104), memory (106), persistent storage (108), peripheral device(s) (110)) that are represented as virtual resources, within the virtual machine (116), and utilized by the software executing therein. Virtual resources may be aggregated from one or more computing device(s) (102) and presented as a unified entity to software executing in the virtual machine (116). As a non-limiting example, a single continuous virtual memory region may correspond to two different physical memory devices (106) physically disposed in two different computing devices (102). Similarly, as another non-limiting example, a virtual machine may provide a virtual processor that corresponds to one or more physical processor(s) (104), only a portion of a single processor (104), and/or two or more portions of two or more processors (104), respectively.

In one or more embodiments, a virtual machine (116) supports the smart data accelerator interface (SDXI) protocol for memory-to-memory data transfer. Further utilization of the SDXI protocol allows for secure communication over memory channels, including the exposure of virtual resources (e.g., virtual processor(s), virtual memory, virtual storage, virtual peripheral devices) and to securely read, write, and process data using those resources. Further, the SDXI protocol allows for the chaining of multiple virtual machines (116) together to allow for a secure “pipeline” of data processing from one virtual machine to another.

In one or more embodiments, a rack (e.g., rack (111)) is a physical structure that houses and/or rigidly connects two or more computing devices (102). A rack (111) may be constructed using any number of suitable materials (e.g., metals, polymers, etc.). One of ordinary skill in the art, having the benefit of this detailed description, would appreciate that a rack (111) may be constructed using any quantity and combination of suitable materials without departing from the scope of the technology.

### FIG. 1B

FIG. 1B shows a diagram of a domain, in accordance with one or more embodiments. While a specific configuration of a domain is shown, other configurations may be used without departing from the disclosed embodiment. Accordingly, embodiments disclosed herein should not be limited to the configuration of devices and/or components shown.

In one or more embodiments, a domain (115) is logical construct of two or more physical rack(s) (e.g., rack A (111A), rack N (111N)). Racks (111) may be grouped into a domain (115) based on physical layout (e.g., all of the racks (111) in the same row, all of the racks (111) in the same data center). A domain (115) may be created around a specific function of the computing devices (102) therein (e.g., web server, data storage) and/or based on some other shared property (e.g., all rented by the same customer, including a certain type of hardware). One of ordinary skill in the art, having the benefit of this detailed description, would appreciate that a domain may be created based on any property of the computing devices in one or more rack(s).

### FIG. 1C

FIG. 1C shows a diagram of a creation request, in accordance with one or more embodiments. While a specific configuration of a creation request is shown, other configurations may be used without departing from the disclosed embodiment. Accordingly, embodiments disclosed herein should not be limited to the configuration of devices and/or components shown.

In one or more embodiments, a creation request (130) is a data structure that includes virtual machine parameters (134). Virtual machine parameters (134) include metadata about a virtual machine (116), used by the virtual machine manager (114), to create and maintain the virtual machine (116). In one or more embodiments, virtual machine parameters may include:
(i) the computing resources required to execute the virtual machine (e.g., two x86 processor threads, 8 GB of RAM, three GPUs, etc.),
(ii) policies of the virtual machine (e.g., processor (104) cores must be on the same computing device (102), entire memory (106) device must be exclusive, “best available” hardware, geographic requirements etc.),
(iii) customer information (e.g., name, account number, contact information, etc.), and/or
(iv) any other information about a virtual machine (116).

### FIG. 1D

FIG. 1D shows a diagram of a computing resource database, in accordance with one or more embodiments. While a specific configuration of a computing resource database is shown, other configurations may be used without departing from the disclosed embodiment. Accordingly, embodiments disclosed herein should not be limited to the configuration of devices and/or components shown.

In one or more embodiments, a computing resource database (112) is a data structure that includes one or resource entries (e.g., resource entry A (150A), resource entry N (150N)). In one or more embodiments, a resource entry (150) is a data structure that includes any one, or combination, of the following data:
(i) a resource identifier (154) that uniquely identifies a single computing resource associated with the resource entry (150) (non-limiting examples of an identifier include a tag, an alphanumeric entry, a filename, and a row number in table). In one or more embodiments, a single computing resource may be a portion of a larger computing resource (e.g., each core of a single processor (104) may have its own resource entry (150)),
(ii) resource specifications (156) that provides information about a computing resource (i.e., the computing resource uniquely identified by the resource identifier (154)) (described below),
(iii) resource utilization data (158) that includes data related to the usage of a computing resource (i.e., the computing resource uniquely identified by the resource identifier (154)) (described below),
(iv) a computing device identifier (152) that uniquely identifies a single computing device associated with the resource entry (150), and/or
(v) a virtual machine identifier (162) that uniquely identifies a single virtual machine (116) associated with the computing resource that is uniquely identified by the resource identifier (154),

In one or more embodiments, resource specifications (156) detail the properties, features, and functionalities of a computing resource. As a non-limiting example, if the computing resource is a processor (104), then the resource specifications (156) may specify one or more properties of the processor(s) (104), including the architecture (e.g., x86, ARM, etc.), the manufacturer/model, core count, thread count, clock speed(s), cache size, memory channels, and/or any other information about the specific processor (104). As another non-limiting example, if the computing resource is associated with a memory (106) device, then the resource specifications (156) may specify one or more properties of the memory device(s) (106), including the capacity (e.g., 4 GB, 32 GB, etc.), clock frequency, cell type (e.g., DRAM, SRAM, etc.), and/or any other information about the specific memory (106) device. As a third non-limiting example, if the computing resource is a persistent storage (108) device, then the resource specifications (156) may specify properties of the persistent storage (108), including the capacity (e.g., 512 GB, 12 TB, etc.), type (e.g., magnetic disk, solid state, etc.), read/write speed, spin speed (if applicable), and/or any other information about the specific persistent storage (108) device.

In one or more embodiments, resource utilization data (158) includes measurements of usage and capacity of computing resources. Non-limiting examples of resource utilization data (158) include, but are not limited to, (i) processor (104) utilization (e.g., 50%, 5 of 8 cores in use), (ii) memory (106) utilization (e.g., 14 GB used, 2 GB available), (iii) persistent storage utilization (e.g., 1.3 TB used, 10.7 TB free), and/or (iv) GPU utilization (e.g., “in use”, “not in use”), etc.

### FIG. 1E

FIG. 1E shows a diagram of an allocation database, in accordance with one or more embodiments. While a specific configuration of an allocation database is shown, other configurations may be used without departing from the disclosed embodiment. Accordingly, embodiments disclosed herein should not be limited to the configuration of devices and/or components shown.

In one or more embodiments, an allocation database (113) is a data structure that may include one or more allocation entries (e.g., allocation entry A (160A), allocation entry N (160N)). In one or more embodiments, an allocation entry (160) is a data structure that includes any one, or combination, of the following data:
(i) a virtual machine identifier (162) that uniquely identifies a single virtual machine (116) associated with the allocation entry (160),
(ii) virtual machine parameters (134) (discussed in the description of FIG. 1C), and/or
(iii) one or more resources identifiers (e.g., resource identifier A (154A), resource identifier N (154N)) that each identify a single computing resource associated with the allocation entry (160). Each resource identifier (154) is uniquely associated with a single resource entry (150) in the computing resource database (112).

### FIG. 2A

FIG. 2A shows a flowchart of a method for creating a virtual machine, in accordance with one or more embodiments. All or a portion of the method shown may be performed by the virtual machine manager. However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 200, the virtual machine manager receives a creation request to create a virtual machine. As discussed in the description of FIG. 1C, the creation request may specify virtual machine parameters specifying the minimum requirements and constraints required for the virtual machine.

In Step 202, the virtual machine manager identifies suitable computing resources, via the computing resource database, which satisfy the requirements specified in the virtual machine parameters. In one or more embodiments, the virtual machine manager performs a lookup, in the computing resource database, to identify and locate resource entries matching, satisfying, or exceeding one or more of the specified requirements (of the virtual machine parameters).

As a non-limiting example, virtual machine parameters may require four processor cores for the creation of a new virtual machine. Further, the virtual machine parameters may require that the four processor cores be located in the same computing device and be utilized exclusively by the virtual machine. In such an instance, the virtual machine manager searches the computing resource database and identifies four available (e.g., unallocated, unused) processor cores within the same computing device.

As another non-limiting example, virtual machine parameters may require three processor cores for the creation of a new virtual machine. However, the virtual machine parameters do not specify any further restrictions for the location of those processor cores. Accordingly, the virtual machine manager searches the computing resource database and identifies three unused processor cores located in three different computing devices.

In Step 204, the virtual machine manager allocates the identified computing resources for the virtual machine and initiates the virtual machine using those resources. The allocated computing resources may be treated as virtual resources within the virtual machine (e.g., one or more physical processor(s) may be represented as one or more virtual resource(s) in the virtual machine). After allocating the computing resources for the virtual machine, the virtual machine manager initiates execution of the virtual machine by ‘booting up’ the virtual machine.

### FIG. 2B

FIG. 2B shows a flowchart of a method for monitoring computing resources and enforcing virtual machine parameters, in accordance with one or more embodiments. All or a portion of the method shown may be performed by the virtual machine manager. However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 206, the virtual machine manager monitors the utilization of computing resources. In one or more embodiments, the virtual machine manager may request and receive (or otherwise obtain) utilization data from a computing resource and/or a computing resource may publish (or otherwise ‘push’) utilization data to the virtual machine manager. In turn, upon receipt of utilization data from a computing resource, the virtual machine manager updates the utilization data in the resource entry (of the computing resource database) associated with the computing resource.

In Step 208, the virtual machine manager compares the virtual machine parameters against the resource entries. In one or more embodiments, the virtual machine manager selects an allocation entry (in the allocation database) and matches each of the resource identifiers against matching resource identifiers in the computing resource database. In one or more embodiments, the virtual machine manager identifies resource entries (in the computing resource database) by matching the virtual machine identifiers with the virtual machine identifier in the allocation entry. Accordingly, for each computing resource allocated to a single virtual machine, the virtual machine manager may analyze the (i) resource specification, (ii) resource utilization data, and/or (iii) computing device identifier, to ensure compliance with the virtual machine parameters.

In Step 210, the virtual machine manager determines if the virtual machine parameters are violated (or soon to be violated) based on the resource entries. In one or more embodiments, as a non-limiting example, if a computing resource is initially allocated to a virtual machine that does not actively utilize the computing resource, the virtual machine manager may temporarily re-allocate that computing resource to a non-priority virtual machine for non-priority usage. However, if the original virtual machine then begins to (or otherwise attempts to) use the re-allocated computing resource, the virtual machine parameters would be violated.

If the virtual machine manager determines that virtual machine parameters are not being violated (Step 210-NO), the method ends. However, if the virtual machine manager determines that the virtual machine parameters are violated (Step 210—YES), the method proceeds to Step 212.

In Step 212, the virtual machine manager reallocates computing resources, as necessary, to comply with the virtual machine parameters. In one or more embodiments, continuing with the example above, if a computing resource is temporarily re-allocated to a non-priority virtual machine, that computing resource may be re-allocated back to the original virtual machine to satisfy the virtual machine parameters.

### FIG. 2C

FIG. 2C shows a flowchart of a method for scaling virtual machines based on computing resource utilization, in accordance with one or more embodiments. All or a portion of the method shown may be performed by the virtual machine manager. However, another component of the system may perform this method without departing from the embodiments disclosed herein. While the various steps in this flowchart are presented and described sequentially, one of ordinary skill in the relevant art (having the benefit of this detailed description) would appreciate that some or all of the steps may be executed in different orders, combined, or omitted, and some or all steps may be executed in parallel.

In Step 214, the virtual machine manager initiates a virtual machine. This step is substantially similar to the process described in FIG. 2A.

In Step 216, the virtual machine manager analyzes the computing resource database to identify unused resources that may be allocated to an existing virtual machine. In one or more embodiments, the virtual machine manager may identify scalable virtual machines that are fully utilizing their existing computing resources. Then, based on the already-allocated computing resources, the virtual machine manager searches the computing resources database to identify additional available computing resources suitable to scale-up the virtual machine.

In Step 218, the virtual machine manager makes a determination if there are available resources to allocate to the virtual machine. If the virtual machine manager does not identify available additional resources for the virtual machine (Step 218-NO), the method may end. However, if the virtual machine manager identifies available additional resources for the virtual machine (Step 218—YES), the method proceeds to Step 220.

In Step 220, the virtual machine manager allocates the identified computing resources to the virtual machine (e.g., scaling-up the virtual machine). Accordingly, the virtual machine is provided with additional capacity to perform one or more workloads that were saturating the virtual machine's previously-allocated computing resources.

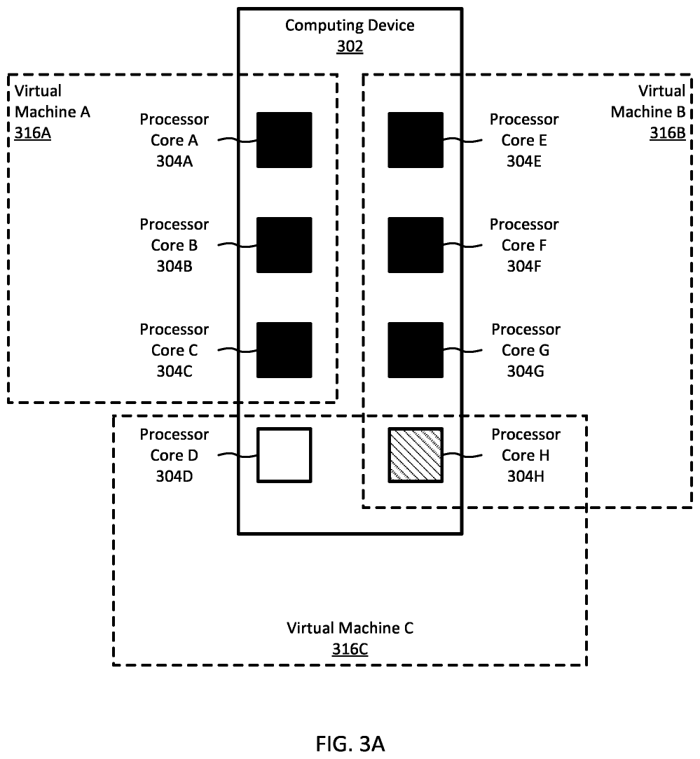

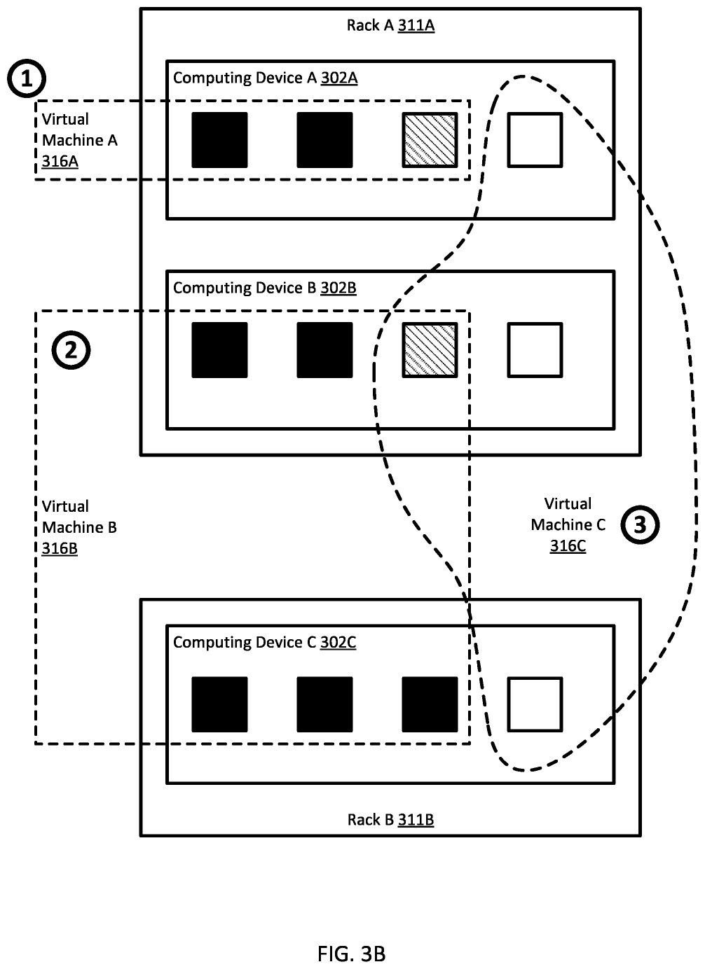

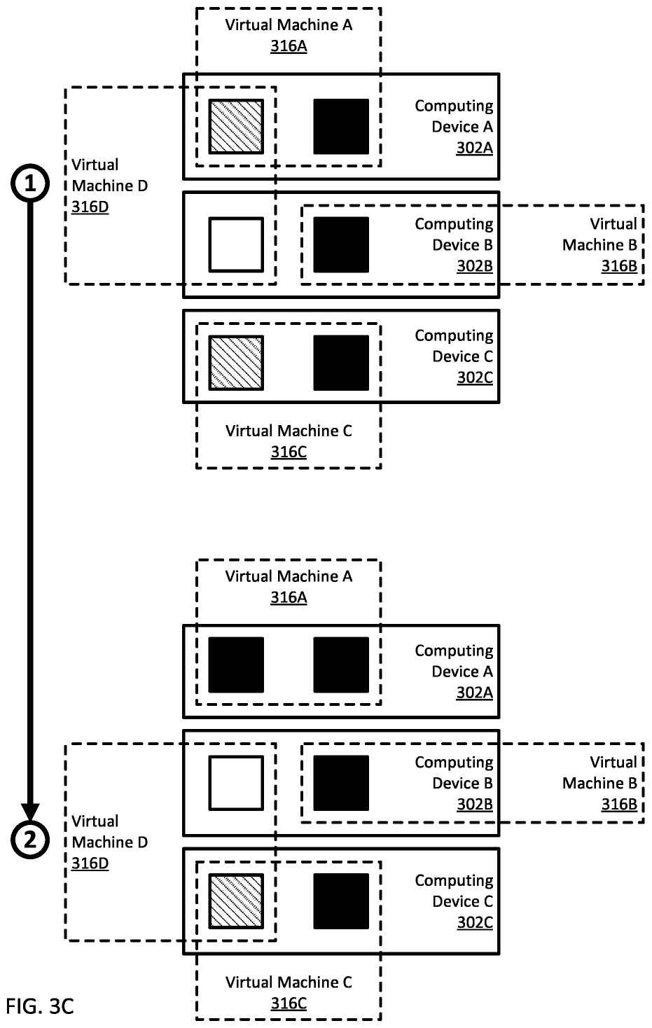

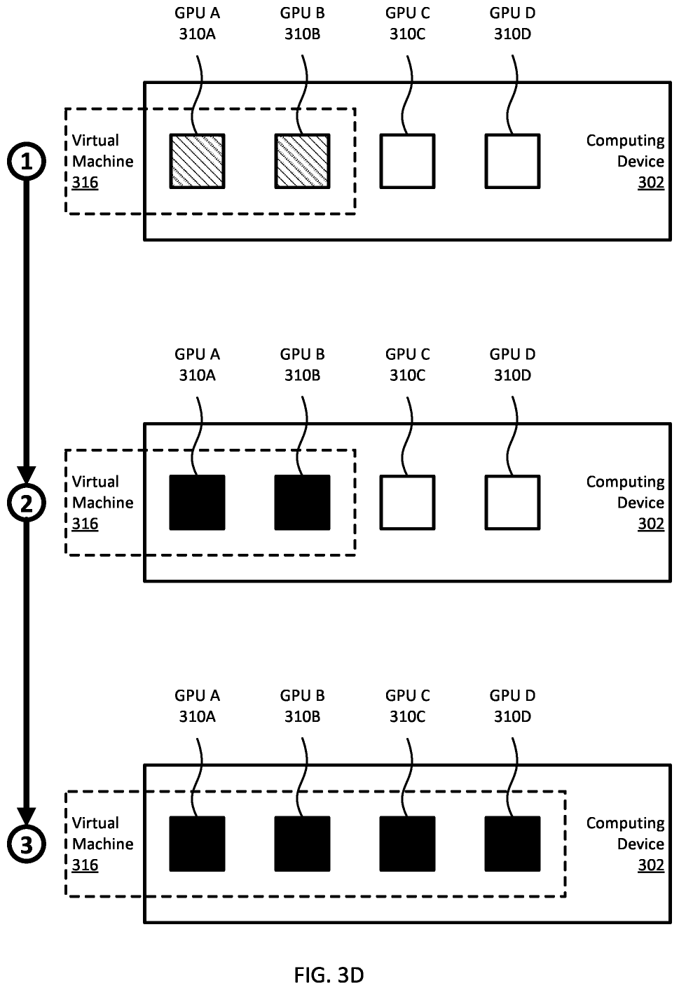

### FIG. 3A

FIG. 3A shows an example of computing resources allocated to multiple virtual machines, in accordance with one or more embodiments. As shown in FIG. 3A, the computing device (302) includes eight processor cores (304) (processor core A (304A), processor core B (304B), processor core C (304C), processor core D (304D), processor core E (304E), processor core F (304F), processor core G (304G), and processor core H (304H)). The example is not intended to limit the scope of the technology.

Initially, consider a scenario with only virtual machine A (316A) and virtual machine B (316B) (and not virtual machine C (316C)). In such an instance, virtual machine A (316A) is allocated three processor cores (304A, 304B, and 304C), and virtual machine B (316B) is allocated four processor cores (304E, 304F, 304G, and 304H). Accordingly, processor core D (304D) is left unallocated to any virtual machine. Further, as processor core D (304D) is the only processor core unallocated, and virtual machines (316A, 316B) usually request more than one processor core (304), processor core D (304D) is therefore “stranded”. Additionally, although processor core H (304H) is allocated to virtual machine B (316B), virtual machine B (316) is not utilizing processor core H (304H) and is sitting idle on the computing device (302).

At some point later, virtual machine C (316C) is created with virtual machine parameters merely requiring “available” computing resources. Accordingly, virtual machine C (316C) is allocated two processor cores (304D, 304H). While processor core D (304D) is unallocated and unused, processor core H (304H) is already allocated to virtual machine B (316B). However, as the virtual machine manager (not shown) monitors the utilization of the processor cores (304), the virtual machine manager is configured to alternate the allocation of processor core H (304H) to both virtual machine B (316B) and virtual machine C (316C), as needed. Further, as virtual machine C (316) is only allocated “available” computing resources, virtual machine B (316B) is given priority to processor core H (304H) over virtual machine C (316C). Accordingly, virtual machine C (316C) can only utilize processor core H (304H) when not being utilized by virtual machine B (316B).

### FIG. 3B

FIG. 3B shows an example of computing resources allocated to multiple virtual machines, in accordance with one or more embodiments. As shown in FIG. 3B, there are two racks (rack A (311A) and rack B (311B)). Rack A (311A) includes computing device A (302A) and computing device B (302B), while rack B (311B) includes computing device C (302C). Further, each computing device (302A, 302B, 302C) includes four graphics processing units (GPUs) (shown as outlined, striped, or solid squares). The example is not intended to limit the scope of the technology.

At (1), virtual machine A (316A) is created with virtual machine parameters requiring three GPUs in the same computing device (302). Further, the virtual machine parameters specify that the GPUs need to be exclusive to the virtual machine and immediately available for use. Accordingly, virtual machine A (316A) is allocated three GPUs of computing device A (302) (i.e., the three leftmost square boxes). Additionally, although virtual machine A (316A) is allocated three GPUs, virtual machine A (316A) is only actively utilizing two of those GPUs, leaving the third GPU unused (denoted by the striped square).

At (2), virtual machine B (316B) is created with virtual machine parameters requiring six GPUs. Additionally, the virtual machine parameters require that three of the GPUs must be co-located in a first computing device (302), while the other three must be co-located in a different, second computing device (302). However, the virtual machine parameters do not require that the two sets of GPUs be located in the same rack (311) and therefore may be located anywhere in the domain (which in this example includes rack A (311A) and rack B (311B)). Unlike virtual machine A (316A), the GPUs allocated to virtual machine B (316B) are not required to be exclusive to virtual machine B (316B). Thus, while virtual machine B (316B) is given priority to any allocated GPUs, any unused GPU(s) may be allocated to another virtual machine (316) (while unused). Accordingly, virtual machine B (316B) is allocated three GPUs in computing device B (302B) and three GPUs in computing device C (302C).

At (3), virtual machine C (316C) is created with virtual machine parameters requiring two-to-six available GPUs, with no restrictions on co-location in the same computing device (302A, 302B, 302C) or rack (311A, 311B). Accordingly, the virtual machine manager identifies three wholly stranded GPUs, one in each computing device (302A, 302B, 302C) (the rightmost GPU in each computing device), that are not allocated to any existing virtual machine (316A, 316B). Further, a GPU in computing device B (302B) that is allocated to virtual machine B (316B) is not being used.

Accordingly, virtual machine C (316C) is allocated each of the three stranded GPUs and is further allocated the third GPU (third from the left) in computing device B (302B). However, virtual machine C (316C) is not allocated the third GPU (third from the left) in computing device A (302A) as the virtual machine parameters for virtual machine A (302A) require that all allocated computing resources be exclusive to virtual machine A (316A)—thereby preventing the alternating allocation of any of those three GPUs, regardless of usage.

### FIG. 3C

FIG. 3C shows an example of computing resources allocated to multiple virtual machines, in accordance with one or more embodiments. As shown in FIG. 3C, there are three computing devices (computing device A (302A), computing device B (302B), and computing device C (302C)), each with two processor cores (shown as outlined, striped, or solid squares). The computing devices (302A, 302B, 302C) are shown at two different points in time ((1) and (2)), described below. The example is not intended to limit the scope of the technology.

At (1), virtual machine A (316A) is allocated the two processor cores of computing device A (302A). However, virtual machine A (316A) is only using one of those processor cores (the right one), leaving the other (the left one) unused. Virtual machine B (316B) is allocated and actively using one of the processor cores of computing device B (302B). Virtual machine C is allocated the two processor cores of computing device C (302C). However, virtual machine C (316C) is only using one of those processor cores (the right one), leaving the other (the left one) unused. Virtual machine D (316D) is created with virtual machine parameters requiring two available processor cores. Accordingly, virtual machine D (316D) is allocated the unallocated (and “stranded”) processor core of computing device B (302B). Further, virtual machine D (316D) is allocated the already-allocated, but unused, processor core of computing device A (302A).

At (2), virtual machine A (316A) begins to initiate workloads on both of the processor cores in computing device A (302A). In such an instance, the virtual machine parameters (of virtual machine A (316A)) are being violated as virtual machine D (316D) is utilizing the second core of computing device A (302A). Accordingly, as virtual machine A (316A) is given priority over the allocated processor cores, the processor core is deallocated from virtual machine D (316D) in order to enforce the virtual machine parameters of virtual machine A (316A). Further, to maintain the virtual machine parameters for virtual machine D (316), a second available processor core is allocated to virtual machine D (316) (on computing device C (302C)). Accordingly, the virtual machine parameters for each virtual machine (316) are satisfied.

### FIG. 3D

FIG. 3D shows an example of computing resources allocated to a virtual machine, in accordance with one or more embodiments. As shown in FIG. 3D, there is a single computing device (302) with four GPUs (GPU A (310A), GPU B (310B), GPU C (310C), and GPU D (310D)). The example is not intended to limit the scope of the technology.

At (1), a virtual machine (316) is created with virtual machine parameters requiring two GPUs (310). Accordingly, the virtual machine (316) is allocated GPU A (310A) and GPU B (310B). Thereafter, the virtual machine (316) begins fully utilizing the allocated GPUs.

At (2), the virtual machine manager (not shown) analyzes the computing resource database (not shown) and determines that the virtual machine (316) is fully utilizing both of the allocated GPUs (310A, 310B). Further, the virtual machine manager identifies that GPU C (310C) and GPU D (310D) are unallocated and unused.

At (3), the virtual machine manager allocates the two additional GPUs (310C, 310D) to the virtual machine (316). Thereafter, the virtual machine (316) scales-up the workload(s) being processed to use all four allocated GPUs (310).

What is claimed is:

1. A method for allocating stranded computing resources, the method comprising:
obtaining, by a virtual machine manager, virtual machine parameters for a virtual machine;
identifying, in a computing resource database, a stranded computing resource satisfying the virtual machine parameters;
allocating, to the virtual machine, the stranded computing resource; and
initiating the virtual machine using the stranded computing resource.

2. The method of claim 1, wherein identifying the stranded computing resource comprises:
making a first determination, using the computing resource database, that the stranded computing resource is unused.

3. The method of claim 2, wherein based on the first determination, the method further comprises:
deallocating the stranded computing resource from a second virtual machine.

4. The method of claim 3, wherein after initiating the virtual machine, the method further comprises:
making a second determination, using an allocation database, that second virtual machine parameters are violated, wherein the second virtual machine parameters are associated with the second virtual machine; and
based on the second determination:
deallocating the stranded computing resource from the virtual machine; and
re-allocating the stranded computing resource to the second virtual machine.

5. The method of claim 1, wherein obtaining the virtual machine parameters comprises:
receiving a creation request comprising the virtual machine parameters.

6. The method of claim 1, wherein after initiating the virtual machine, the method further comprises:
identifying, in the computing resource database, an unallocated computing resource satisfying the virtual machine parameters; and
allocating, to the virtual machine, the unallocated computing resource.

7. The method of claim 6, wherein prior to identifying the unallocated computing resource, the method further comprises:
making a first determination, using an allocation database, that the virtual machine is fully utilizing the stranded computing resource,
wherein identifying the unallocated computing resource is based on the first determination.

8. The method of claim 1, wherein the stranded computing resource is a processor core in a processor, wherein the processor comprises a plurality of other processor cores allocated to a second virtual machine.

9. The method of claim 1, wherein the stranded computing resource is a memory region on a memory device, wherein the memory device comprises a plurality of other memory regions allocated to a second virtual machine.

10. The method of claim 1, wherein the stranded computing resource is a graphics processing unit in a computing device, wherein the computing device comprises a plurality of other graphics processing units allocated to a second virtual machine.

11. A non-transitory computer readable medium comprising instructions which, when executed by a processor, enables the processor to perform a method for allocating stranded computing resources, the method comprising:
obtaining, by a virtual machine manager, virtual machine parameters for a virtual machine;
identifying, in a computing resource database, a stranded computing resource satisfying the virtual machine parameters;
allocating, to the virtual machine, the stranded computing resource; and
initiating the virtual machine using the stranded computing resource.

12. The non-transitory computer readable medium of claim 11, wherein identifying the stranded computing resource comprises:
making a first determination, using the computing resource database, that the stranded computing resource is unused.

13. The non-transitory computer readable medium of claim 12, wherein based on the first determination, the method further comprises:
deallocating the stranded computing resource from a second virtual machine.

14. The non-transitory computer readable medium of claim 13, wherein after initiating the virtual machine, the method further comprises:
making a second determination, using an allocation database, that second virtual machine parameters are violated, wherein the second virtual machine parameters are associated with the second virtual machine; and
based on the second determination:
deallocating the stranded computing resource from the virtual machine; and
re-allocating the stranded computing resource to the second virtual machine.

15. The non-transitory computer readable medium of claim 11, wherein obtaining the virtual machine parameters comprises:
receiving a creation request comprising the virtual machine parameters.

16. The non-transitory computer readable medium of claim 11, wherein after initiating the virtual machine, the method further comprises:
identifying, in the computing resource database, an unallocated computing resource satisfying the virtual machine parameters; and
allocating, to the virtual machine, the unallocated computing resource.

17. The non-transitory computer readable medium of claim 16, wherein prior to identifying the unallocated computing resource, the method further comprises:
making a first determination, using an allocation database, that the virtual machine is fully utilizing the stranded computing resource,
wherein identifying the unallocated computing resource is based on the first determination.

18. The non-transitory computer readable medium of claim 11, wherein the stranded computing resource is a memory region on a memory device, wherein the memory device comprises a plurality of other memory regions allocated to a second virtual machine.

19. A computing device, comprising:
a processor; and
memory storing instructions which, when executed by the processor, enables the processor to perform a method for allocating stranded computing resources, the method comprising:
obtaining, by a virtual machine manager, virtual machine parameters for a virtual machine;
identifying, in a computing resource database, a stranded computing resource satisfying the virtual machine parameters;
allocating, to the virtual machine, the stranded computing resource; and
initiating the virtual machine using the stranded computing resource.

20. The computing device of claim 19, wherein identifying the stranded computing resource comprises:
making a first determination, using the computing resource database, that the stranded computing resource is unused; and
based on the first determination:
deallocating the stranded computing resource from a second virtual machine.
